(19) United States
(12) Patent Application Publication
(10) Pub. No.: US 2010/0125344 A1
(43) Pub. Date: May 20, 2010

(54) CENTRAL SUBASSEMBLY FOR A FLEXIBLE EXPANDABLE AUTOMATION DEVICE

(75) Inventors: Gernot Gaub, Hockenheim (DE); Brigitte Blei, Berlin (DE); Andreas Wilmers, Heidelberg (DE)

Correspondence Address: DARBY & DARBY P.C., P.O. BOX 770, Church Street Station, New York, NY, 10008-0770, US

(73) Assignee: ABB AG, Mannheim (DE)

(21) Appl. No.: 12/621,110

(22) Filed: Nov. 18, 2009

(30) Foreign Application Priority Data
Nov. 18, 2008 (DE) 102008058061.9

(51) Int. Cl. G05B 19/042

(52) U.S. Cl. 700/4; 700/19; 700/7; 700/6

(57) ABSTRACT

A central subassembly for a flexible expandable automation device includes a housing, at least one external expansion module connectable via an input/output bus, a first, a second and a third electronic subassembly, and at least one application program. The first electronic subassembly has a central processing unit in a form of a first microcontroller, a volatile memory configured to store at least one of data of an operating system, data of an application program and variables of the application program, and a flash memory for non-volatile buffering of the data. The second electronic subassembly has a plurality of second inputs and second outputs each configured to connect each of a plurality of process signals. The third electronic subassembly is configured to supply voltage to the central subassembly. The first, second and third electronic subassemblies are disposed in the housing.

Priority is claimed to German Application No. DE 10 2008 058 061.9, filed on Nov. 18, 2008, the entire disclosure of which is incorporated by reference herein.

The invention relates to a central subassembly for a flexible expandable automation device.

### BACKGROUND

Commercially available expandable automation devices (also known as programmable logic controllers) or expandable automation devices described in patent documents can be adapted to a wide variety of automation tasks and are used, in particular, in the field of industrial automation technology and in the field of switching and control technology.

Automation devices are usually constructed in modular form from a central subassembly, communication couplers and expansion modules such as external input/output devices. The central subassembly according to the known prior art comprises different subassemblies such as a central processing unit (also referred to as a CPU), a voltage supply and an interface for connecting external input and output modules. The external input/output modules are electrically connected to the central subassembly via an internal bus connection in the form of an input/output bus.

At present, non-volatile storage of remanent data, that is to say program variables, for example of an operating system or an application program, is based on static data storage modules which are supplied with a supply voltage from an energy store (battery, capacitor or rechargeable battery) when the automation device is switched off and can therefore retain the values of the variables.

### SUMMARY OF THE INVENTION

An aspect of the present invention provides specifying a central subassembly for a flexible expandable automation device in which non-volatile storage of data, in particular variables of an application program, is ensured independently of an energy store in the central subassembly and the computation power of the CPU in the central subassembly is reduced.

The central subassembly according to the invention can be expanded with at least one external expansion module which can be connected via an input/output bus and is preferably in the form of an external input/output module. An interface for connecting the external input/output module, a first electronic subassembly having a central processing unit in the form of a microcontroller, a second electronic subassembly having inputs and outputs for connecting the central subassembly to a process, and a third electronic subassembly for supplying voltage to the central subassembly are arranged in the housing of the central subassembly.

The first electronic subassembly in the central subassembly has a first microcontroller, a volatile memory for storing data, for example of an operating system, an application program and variables of the application program, during operation of the central subassembly, and a flash memory for non-volatile buffering of the data stored in the volatile memory. At least one application program and an operating system (also referred to as firmware) are respectively stored in the memories.

The data transmitted to the flash memory from the volatile memory are referred to as remanent data below since they are retained in the flash memory in the event of a voltage failure in the central subassembly.

If the central subassembly of the automation device is in the operating state, the remanent data are stored in the volatile memory and are used by the application program in the memory. The application program is executed by the first microcontroller.

According to the invention, a first function which stores the remanent data in the flash memory when the voltage supply for the central subassembly fails is integrated in the application program.

A second function which copies the data which have been previously stored in the flash memory to the volatile memory again when the voltage returns using the second function is also integrated in the application program.

Data are interchanged between the volatile memory and the flash memory by the first microcontroller using an internal address/data control bus.

The use of the flash memory for intermediate storage of the data thus advantageously ensures non-volatile storage of the data, preferably the application program variables, of the central subassembly of the automation device.

In one refinement of the central subassembly according to the invention, a second cost-effective microcontroller is provided, as a preprocessor, in the second electronic subassembly in the central subassembly, which microcontroller is connected to the inputs and outputs arranged on the second electronic subassembly and controls and evaluates the process voltages, switching and/or control signals from the process which are applied to the inputs and outputs as well as the signals output from the first microcontroller (also referred to as process signals below) for the first microcontroller. The process signals are preprocessed using programs stored in the second microcontroller.

Examples of preprocessing functions are:
input filtering for digital input signals with a time constant which can be parameterized,
implementation of analogue value measurements,
implementation of analogue value outputs,
counter functions, for example counting up/down, or incremental signals as a fast counter function, and
provision of a digital output with a periodic square-wave signal with an adjustable pulse width.

The second microcontroller which is in the central subassembly according to the invention and is used as a preprocessor advantageously makes it possible to reduce the computation power of the first central microcontroller in the central subassembly of the automation device.

In addition, as a result of the fact that a fast counter function is integrated in the second microcontroller, the computation power of the first microcontroller is likewise not taken up for this function.

One advantageous refinement of the central subassembly according to the invention provides for the hardware structure of the second microcontroller to be partially used, for example by means of a digital converter integrated in the second microcontroller, to implement analogue value measurements and analogue value outputs without taking up the computation power of the first microcontroller.

In one particular refinement of the central subassembly, the second microcontroller in the central subassembly is connected to parameterizable input signal filtering for digital input signals, the function of the parameterizable input signal filtering being integrated in the application program of the second microcontroller.

The first and second microcontrollers communicate via a serial communication interface.

For fast signal transmission between the first and second microcontrollers, for example if the speed of serial transmission via the communication interface does not suffice, the first microcontroller is connected to the second microcontroller via parallel digital signal lines in another advantageous refinement of the central subassembly according to the invention.

The three electronic subassemblies in the central subassembly are each preferably arranged on a separate carrier which is in the form of a printed circuit board. The third carrier with the third electronic subassembly is preferably arranged between the second carrier with the second electronic subassembly and the first carrier with the first electronic subassembly.

The first and second carriers of the central subassembly are mechanically and electrically connected to the third carrier. The carriers are preferably soldered to one another for the purpose of mechanical and electrical connection; the carriers are connected by means of soldered pins, for example. This dispenses with the plug connection between the individual carriers and better mechanical stability is achieved.

The carriers are arranged essentially at right angles to one another, the third carrier which accommodates the voltage supply and the interface for connecting the external input and output modules being arranged between the second carrier, which accommodates the internal input and output modules, and the first carrier which accommodates the central processing unit.

In one preferred embodiment of the central subassembly, only the first and third carriers have connecting elements, preferably terminals, plug connectors or terminal blocks which can be plugged or soldered, for example for connecting external signals from further external expansion modules which are in the form of input and output modules, for example. The number of plug connections between the three electronic subassemblies or carriers is thus reduced since the carriers are soldered to one another and the electrical connection between the carriers is ensured without additional plug connections.

In one preferred embodiment of the central subassembly, the Ethernet interface and/or an apparatus in the form of a slot for accommodating accessories which can be retrofitted is/are also provided on the first carrier. The accessories which can be retrofitted may be interchangeable printed circuit boards for further interface circuits or memory cards or for accommodating a real-time clock.

The simplified mechanical structure of the central subassembly with respect to the integration of the functionally different subassemblies on three carriers according to their functions makes the production of the central subassembly cost-effective since the electronic subassemblies arranged on the different carriers can be produced using the respective optimally suitable soldering process.

### BRIEF DESCRIPTION OF THE DRAWINGS

The invention as well as advantageous refinements, improvements and further advantages of the invention shall be described and explained in more detail using the embodiments illustrated in the following figures, in which:

FIG. 1 shows an exemplary automation device,

FIG. 2 shows an exemplary design of the hardware structure of the central subassembly,

FIG. 3 shows, by way of example, the design of the first electronic subassembly,

FIG. 4 shows, by way of example, the design of the second electronic subassembly with the inputs and outputs,

FIG. 5 shows an exemplary design of the third electronic subassembly with the voltage supply for the central subassembly,

FIG. 6 shows an exemplary design of a central subassembly for a flexible expandable automation device,

FIG. 7 shows an exemplary design of the printed circuit boards of the central subassembly with the electronic subassemblies arranged thereon,

FIG. 8 shows an exemplary solution for connecting the printed circuit boards to one another, and

FIG. 9 shows an embodiment of the apparatus which is on the first printed circuit board and is in the form of a slot for accommodating accessories which can be retrofitted.

### DETAILED DESCRIPTION

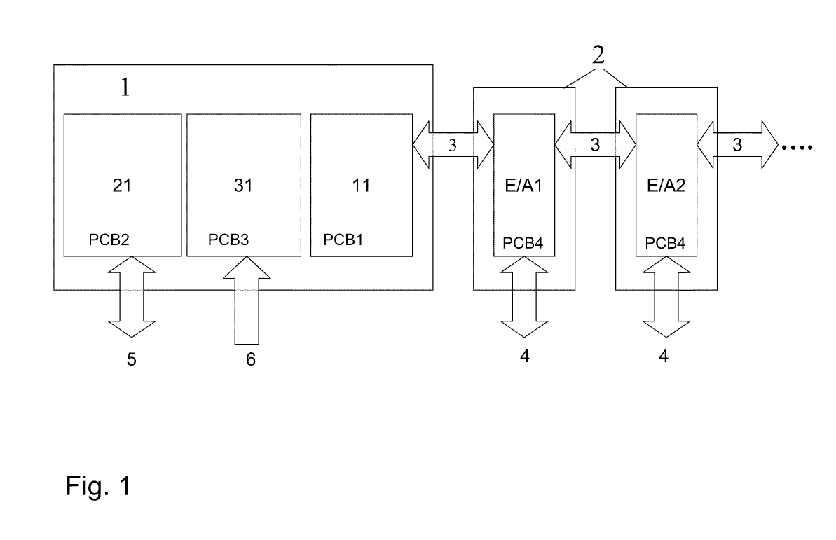

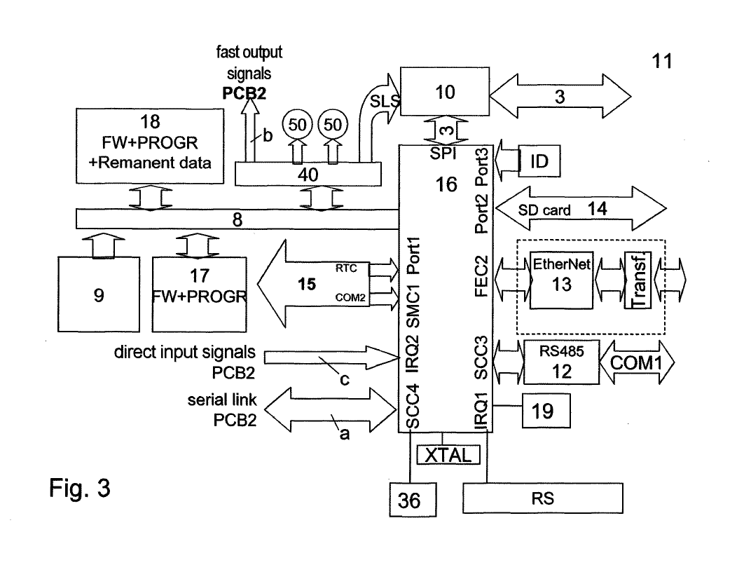

FIG. 1 shows an exemplary automation device with the central subassembly 1 according to the invention which can be expanded with a plurality of external expansion modules 2 which can be connected via an input/output bus 3 and a bus logic module 10 (illustrated in FIG. 3) and are preferably in the form of external input/output modules.

The external input/output modules 2 each have a subassembly PCB4, which comprises one or more printed circuit boards and is intended to accommodate the electronic subassemblies EA1, EA2 of the external input/output modules 2, and are each connected, via an interface 4, to the process connected to the automation device.

The housing 200 of the central subassembly 1 comprises three printed circuit boards PCB1, PCB2, PCB3. The first printed circuit board PCB1 is intended to accommodate a first electronic subassembly 11 for a central processing unit which is formed from a microcontroller, a memory and logic modules. The logic unit for the input/output bus 3 is also arranged on the printed circuit board PCB1.

A second electronic subassembly 21 having an interface 5 for connecting the inputs and outputs of the central subassembly 1 to the process is located on the second printed circuit board PCB2.

The third printed circuit board PCB3 is intended to accommodate a third electronic subassembly 31 having the voltage supply 6 for the central subassembly 1.

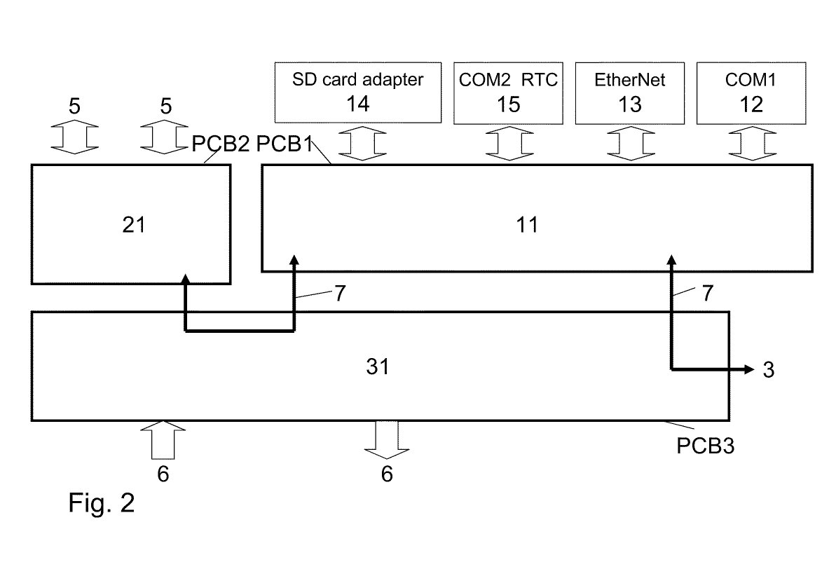

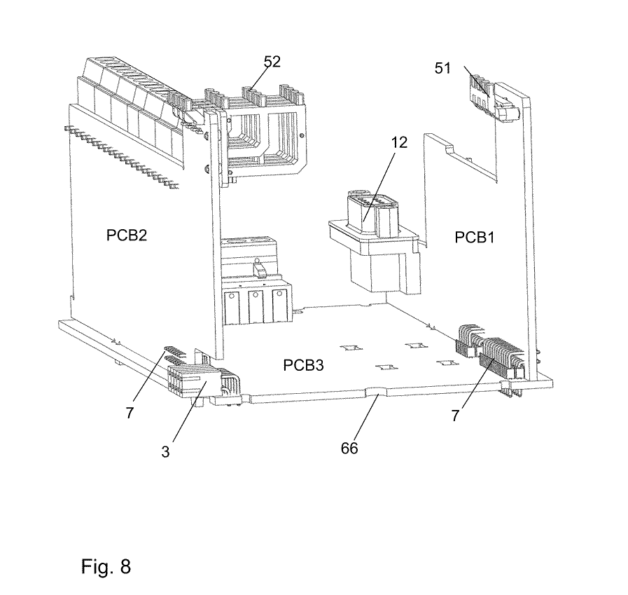

FIG. 2 shows an exemplary design of the hardware structure of the central subassembly 1 having the three electronic subassemblies 11, 21, 31 arranged on the printed circuit boards PCB1, PCB2, PCB3. The printed circuit boards PCB1, PCB2, PCB3 and electronic subassemblies 11, 21, 31 are mechanically and electrically connected to one another, with FIG. 8 showing, by way of example, the connection 7 between the printed circuit boards PCB1, PCB2, PCB3.

The first electronic subassembly 11 in the central subassembly 1 has connections in the form of interfaces for a serial interface 12 in the form of an RS485 interface and an Ethernet interface 13.

An interface 14 for further interface circuits, for example for additional memory cards which are in the form of SD (Secure Digital) memory cards, for example, and a further interface (COM2 RTC) 15 for connection to an additional printed circuit board for accommodating a real-time clock and/or to a second serial interface may also be optionally provided.

The second printed circuit board PCB2 having the connections 5 for digital input and output signals of the connected process is electrically connected to the electronic subassemblies 11, 31 on the first and third printed circuit boards PCB1, PCB3 via the connection 7.

The voltage supply 6 is supplied to the central subassembly 1 via the third printed circuit board PCB3.

The connections for the external input/output modules via the input/output bus 3 are arranged on the third printed circuit board.

FIG. 3 shows, by way of example, the design of the first electronic subassembly 11 in the central subassembly 1 on the printed circuit board PCB1.

The first electronic subassembly 11 has a first microcontroller 16, a volatile memory 17 for storing data, such as the operating system, the application program and the application program variable during the run time, a flash memory 18 for buffering the data stored in the volatile memory 17, and an apparatus 9 for the initial configuration of the first microcontroller 16. At least one application program PROGR and an operating system FW are respectively stored in the memories 17, 18.

The first microcontroller 16 is provided with connections SPI, SCC3, SCC4, SMC1, FEC2 for the parameterizable serial interfaces 3, 10, 12, 13, 15, a connection IRQ1 for voltage failure detection 19, a voltage supply 36 which is supplied to a voltage supply 36 provided by the third electronic subassembly 31, and a RUN/STOP switch RS which may also be in the form of a pushbutton.

The RUN/STOP switch RS is used to start or stop the programs in the central subassembly 1 by using the RUN/STOP switch RS to change over between RUN and STOP.

An RS485 interface is connected to the connection SCC3. The connection FEC2 is intended for an Ethernet interface 13 and the connection SCC4 is intended for serial communication a between the first microcontroller 16 and a second microcontroller 26, for example of the type ATMega16, which is on the second printed circuit board PCB2.

In one particularly advantageous refinement, parallel digital signal lines b are provided for fast signal transmission between the MPC852 controller 16 arranged in the first electronic subassembly 11 and the second microcontroller 26 arranged on the second printed circuit board PCB2, which signal lines transmit the output signals from the MPC852 controller 16 to the second microcontroller 26 in the second electronic subassembly 21 via the address/data control bus 8 and the data or signal memory 40.

Further parallel digital signal lines c which advantageously make it possible to quickly transmit the digital process signals guided via the second printed circuit board PCB2 can also be connected to a further connection IRQ2 of the MPC852 controller 16.

The connections SMC1 and Port1 of the first microcontroller 16 are optionally connected to an additional printed circuit board for accommodating a real-time clock RTC and/or to a second serial interface COM2 via a plug connection which is arranged on the third printed circuit board PCB3 and is intended for a further interface 15.

According to FIG. 3, an MPC852 controller from the PPC family is shown by way of example as the first microcontroller 16. PPC (PowerPC) is representative of the microcontroller technology used. The connections SPI, SCC3, SCC4, SMC1, FEC2 for the serial interfaces 3, 12, 13, 15 of the MPC852 controller mentioned as an example can also be used in another assignment or other microcontroller types from the PPC family or microcontroller types from other microcontroller families can also be used.

According to the invention, the data of the central subassembly 1 of the automation device are stored in a non-volatile manner by virtue of the remanent data being stored in the volatile memory 17 in the operating state of the central subassembly 1 and being used by an application program PROGR of the MPC852 controller 16, which program is stored in the memory. The application program PROGR is executed by the MPC852 controller 16.

According to the invention, a first function which stores the remanent data in the flash memory 18 when the voltage supply 6 for the central subassembly 1 fails is integrated in the application program PROGR.

A second function which copies the data which have been previously stored in the flash memory 18 to the volatile memory 17 again when the voltage returns using the second function is also integrated in the application program PROGR.

The interchange of data between the flash memory 18 and the MPC852 controller 16 and the interchange of data between the volatile memory 17, the flash memory 18 and the apparatus 9 for initializing the initial configuration of the first microcontroller 16 are carried out via an internal address/data control bus 8.

The address/data control bus 8 is also connected to indication means 50, for example for indicating fault messages and/or the operating state of the central subassembly 1, via a data or signal memory 40.

Like the MPC852 controller 16 (at the connection SPI) too, the data or signal memory 40 is connected to a bus logic module 10 for adapting the control signals from the input/output bus 3.

The bus logic module 10 is in the form of a hard-wired logic unit and is intended to connect further external input/output modules via the input/output bus 3.

The MPC852 controller 16 may optionally have a connection for further interface circuits 14, for example for additional memory cards.

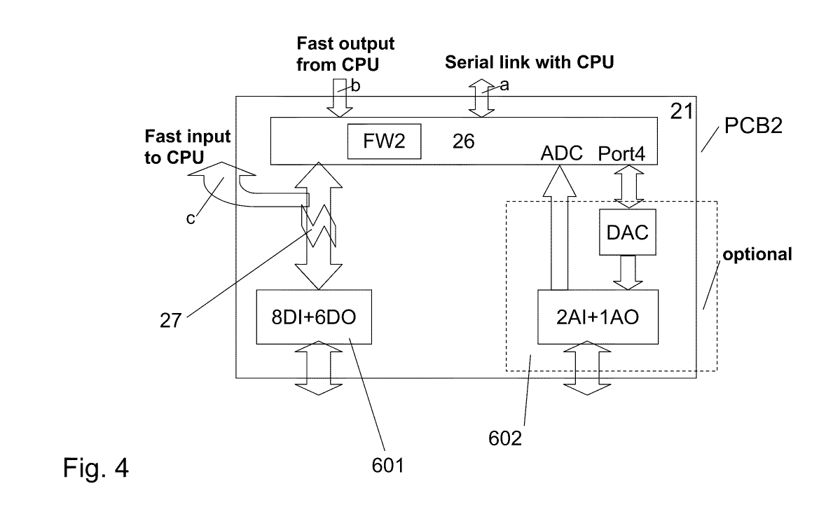

FIG. 4 shows, by way of example, the design of the second electronic subassembly 21 with the inputs and outputs DI, DO, AI, AO for the connected process, which electronic subassembly is arranged on the second printed circuit board PCB2.

The levels of the signals are converted at the internal inputs/outputs or input and output circuits 601, 602. Typical levels on the process side are 0 or 24 V DC for digital signals or 0 to 10 V or 0 to 20 mA for analogue signals. The digital inputs DI and digital outputs DO are insulated from the potential of the second microcontroller 26 with DC isolation 27.

The second electronic subassembly 21 with the second microcontroller 26 arranged therein is connected to the first microcontroller 16 by means of the connection a via the serial interface.

The second microcontroller 26 may also be connected to the first electronic subassembly 11 via the signal lines b, c.

Parallel digital signal lines b are provided for fast signal transmission between the first microcontroller 16 arranged in the first electronic subassembly 11 and the second microcontroller 26 arranged on the second printed circuit board PCB2, which signal lines transmit the output signals from the first microcontroller 16 to the second microcontroller 26 in the second electronic subassembly 26 via the data or signal memory 40 arranged in the first electronic subassembly 11 and the address/data control bus 8.

The further parallel digital signal lines c are provided for the purpose of making it possible to rapidly transmit the digital process signals guided via the second printed circuit board PCB2 to the first microcontroller 16.

In one particular refinement, the second microcontroller 26 is connected to parameterizable input signal filtering for filtering the digital input signals. The input signal filtering is implemented as one of the functions of the operating software FW2 for the second microcontroller 26.

The analogue input signals AI provided by the process and the analogue value outputs AO provided by the central subassembly 1 can optionally be guided via the second microcontroller 26. In this case, the analogue input signals AI and the analogue value outputs AO partially use the hardware structure of the second microcontroller 26. The analogue input signals AI are detected using an analogue/digital converter ADC of the second microcontroller 26 and are processed by the operating software FW2; output values for the analogue output are processed by the operating software FW2 and are transmitted to an additional digital/analogue converter DAC via the inputs/outputs Port4 of the second microcontroller 26. This considerably reduces the used amount of computation power of the first microcontroller 16.

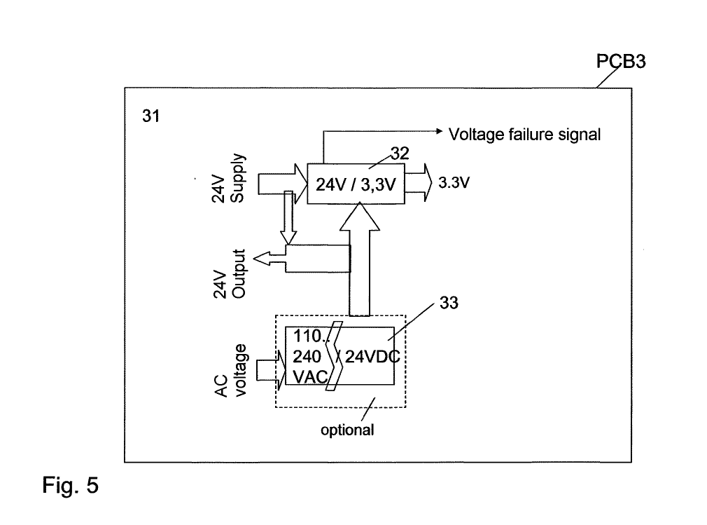

FIG. 5 shows an exemplary design of the third electronic subassembly 31 with the voltage supply for the central subassembly 1.

The voltage supply for the central subassembly 1 is usually supplied with a 24-V input signal which is converted into a system voltage signal or voltage supply signal 36 (typically 3.3 V) for the microcontrollers 16, 26 using a first voltage converter 32.

The first voltage converter 32 also provides a 24-V output signal and the voltage failure signal 34 for the first microcontroller 16.

The voltage supply for the central subassembly 1 may optionally also have a power supply unit or a second voltage converter 33 which converts an AC voltage signal, for example 110-240 V AC, into a DC voltage signal, for example 24V DC, and provides the automation device with the 24-V DC voltage signal for the first voltage converter 32 in the form of a 24-V output signal.

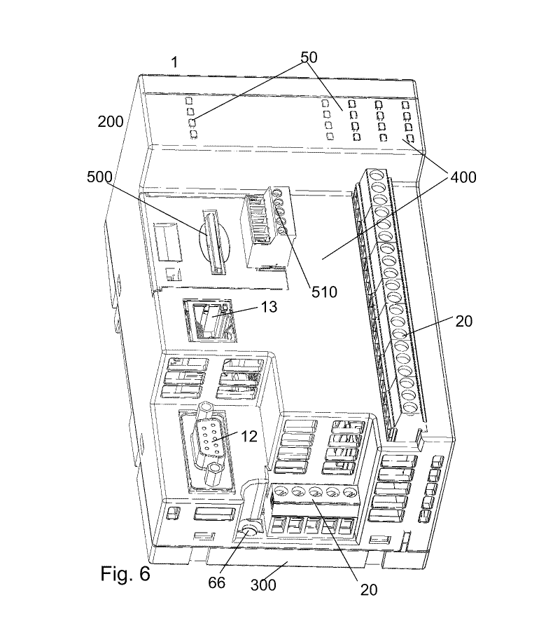

FIG. 6 shows an exemplary design of the housing 200 of the central subassembly 1 for a flexible expandable automation device for controlling and/or monitoring a technical process, the third electronic subassembly 31 for supplying voltage to the central subassembly 1 being arranged on the lower part 300 of said housing, and a housing front side 400.

The serial interface 12, the Ethernet interface 13, an apparatus 500 which can preferably be covered and is in the form of a slot for accommodating the accessories which can be retrofitted, a plug 510 for this apparatus and connecting elements 20 are arranged on the housing front side 400.

In order to accommodate interchangeable printed circuit boards for further interface circuits, for example for an additional serial interface, the apparatus 500 which can be covered and has the slots is provided in the form of a socket for memory cards and/or for accommodating a printed circuit board for a real-time clock.

Furthermore, the housing front side 400 has indication elements 50 for indicating the input and output modules, which elements are in the form of optical waveguides. The optical waveguides are provided for the purpose of focusing the light at a defined point and contactlessly transmitting it to the front side 400 of the central subassembly 1. The light which is focused in the optical waveguides used thus advantageously results in the light being output only at one point on the front side 4 of the central subassembly 1.

In one particular embodiment of the central subassembly 1, the latter is intended for wall mounting. For this purpose, the third printed circuit board PCB3 and the housing lower part 300 are provided with at least one aperture 66 which is intended to accommodate fastening means, preferably screws, for wall mounting.

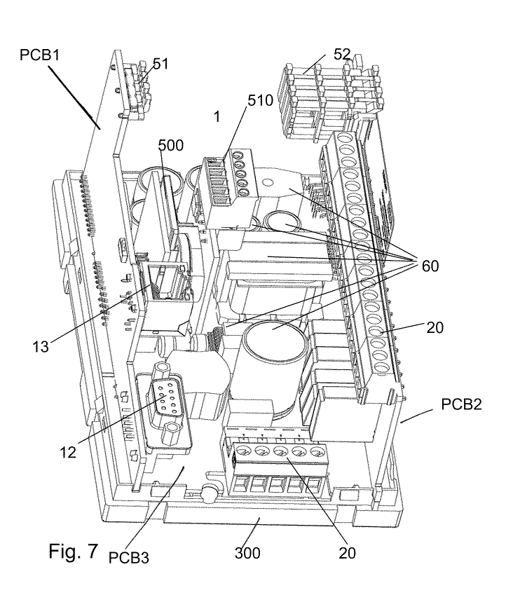

FIG. 7 shows an exemplary design of the printed circuit boards PCB1, PCB2, PCB3 of the central subassembly 1 with electronic subassemblies 11, 21, 31 for a central processing unit, a voltage supply 60 and internal input and output modules, which subassemblies are arranged on said printed circuit boards.

The three electronic subassemblies 11, 21, 31 in the central subassembly 1 are each arranged on a separate printed circuit board PCB1, PCB2, PCB3. The third printed circuit board PCB3 having the voltage supply for the central subassembly 1, which is opposite the housing front side 400 of the central subassembly 1, is arranged, according to the invention, on the housing lower part 300 between the first printed circuit board PCB1 and the second printed circuit board PCB2.

The printed circuit boards PCB1, PCB2, PCB3 are arranged essentially at a right angle to one another, the third printed circuit board being arranged between the first printed circuit board PCB1, which accommodates the central processing unit and the Ethernet interface, and the second printed circuit board PCB2 which accommodates the internal input and output modules with the connecting element 20.

The indication means 50 comprising a first optical waveguide 51 and a second optical waveguide 52 are respectively formed on the first and second printed circuit boards PCB1, PCB2 of the central subassembly 1.

Accessories 500 and 510 which can be retrofitted can be connected to the electronic subassembly 11 via plugs on the first and third printed circuit boards PCB1, PCB3.

FIG. 8 shows the electrical and mechanical connection 7 of the printed circuit boards PCB1, PCB2, PCB3 of the central subassembly 1 which are at a right angle to one another as well as the arrangement of the optical waveguides 51, 52 on the first and second printed circuit boards PCB1, PCB2 and the plug 12 for a communication interface and the plug 3 for the input/output bus.

In order to connect the printed circuit boards PCB1, PCB2, PCB3 to one another, the first and second printed circuit boards PCB1, PCB2 have, in one preferred embodiment, a multiplicity of curved pins which are guided through openings provided in the third printed circuit board PCB3 and are soldered using a wave soldering process, for example.

The printed circuit boards PCB1, PCB2, PCB3 are preferably electrically connected using solder pins.

The above-described electrical and mechanical connection 7 of the printed circuit boards PCB1, PCB2, PCB3 arranged in the central subassembly 1 dispenses with expensive plug connections and better mechanical stability is achieved.

The aperture 66 for accommodating fastening means for mounting the central subassembly 1 on a wall is also shown, by way of example, on the third printed circuit board PCB3.

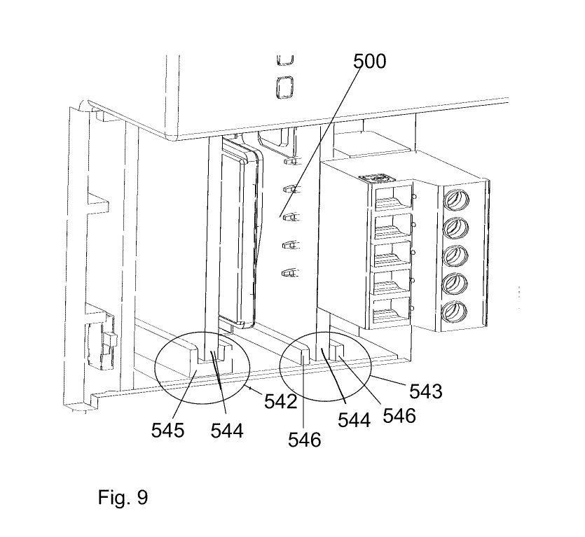

FIG. 9 shows an embodiment of the apparatus 500, which can be covered and is on the first or third printed circuit board PCB1, PCB3, in the form of a slot for accommodating at least one printed circuit board 544 which can be retrofitted, the printed circuit board 544 being intended, for example, for additional interfaces or memory cards and/or to accommodate a real-time clock.

In a first embodiment 542 of the apparatus 500, the printed circuit board 544 which can be retrofitted can be inserted, for example, into a socket formed from a U-shaped rail 545.

In another embodiment 543, the apparatus 500 for accommodating the printed circuit board 544 which can be retrofitted is formed from two elongate rail-shaped elements 546 between which the printed circuit board 544 which can be retrofitted is inserted.

In order to accommodate the printed circuit board 544, the elongate cuboidal elements 546 or the U-shaped rail 545 is/are bevelled or rounded at its/their inner ends facing the printed circuit board 544 to be inserted in order to thus facilitate the accommodation of the printed circuit board 544.

### LIST OF REFERENCE SYMBOLS

1 Central subassembly
2 External expansion module, external input/output module
3 Input/output bus, plug for input/output bus
4 Interface between the expansion modules and the process
5 Interface between the central subassembly and the process
6 Voltage supply for the central subassembly
7 Connection between the carriers
8 Address/data control bus
9 Apparatus for initializing the initial configuration
10 Bus logic module
11 First electronic subassembly
12 Serial interface
13 Ethernet interface
14 Interface for accessories which can be retrofitted
15 Further interface
16 First microcontroller
17 Volatile memory
18 Flash memory
19 Connection for voltage failure detection signal
20 Connecting elements
21 Second electronic subassembly
26 Second microcontroller
27 DC isolation
31 Third electronic subassembly
32 First voltage converter
33 Second voltage converter
34 Voltage failure signal
36 Voltage supply for the microcontroller
40 Data or signal memory
50 Indication element
51 First optical waveguide
52 Second optical waveguide
60 Voltage supply for the central subassembly
66 Aperture
200 Housing
300 Housing lower part
400 Housing front side
500 Apparatus for accommodating accessories which can be retrofitted
510 Plug for apparatus for accommodating accessories which can be retrofitted
541 Opening for accommodating additional printed circuit boards
542 First embodiment for accommodating an additional printed circuit board
543 Second embodiment for accommodating an additional printed circuit board
544 Additional printed circuit board
545 Socket, U-shaped rail
546 Elongate cuboidal element
601, 602 Input and output circuits
a Connection via serial interface for communication between the first microcontroller and the further microcontroller
b Parallel digital signal lines for fast output signals from the first electronic subassembly
c Parallel digital signal lines for fast direct input signals for the first electronic subassembly
ADC Analogue/digital converter
DAC Digital/analogue converter
FW Operating system/firmware
FW2 Operating software/firmware
PROGR Application program
PCB1 First carrier for accommodating the first electronic subassembly in the central subassembly
PCB2 Second carrier for accommodating the second electronic subassembly in the central subassembly
PCB3 Third carrier for accommodating the third electronic subassembly in the central subassembly
PCB4 Carrier for accommodating the electronic subassembly for the external input/output modules
PROGR Application program
RS Run/stop switch
SLS SLS signal
EA1, EA2 Electronic subassemblies of the external input/output modules
SPI, SCC3, SCC4, Connections for parameterizable serial interfaces of the
SMC1, FEC2 microcontroller

What is claimed is:

1. A central subassembly for a flexible expandable automation device, comprising:
a housing;
at least one external expansion module connectable via an input/output bus;
a first electronic subassembly having a central processing unit in a form of a first microcontroller, a volatile memory configured to store at least one of data of an operating system, data of an application program and variables of the application program, and a flash memory for non-volatile buffering of the data;
a second electronic subassembly having a plurality of second inputs and second outputs each configured to connect each of a plurality of process signals;
a third electronic subassembly configured to supply voltage to the central subassembly, the first, second and third electronic subassemblies being disposed in the housing; and
at least one application program executable by at least one of the first microcontroller and the operating system, the at least one application program being stored in at least one of the volatile memory and the flash memory, wherein the at least one application program includes a first function configured to store the data in the flash memory when the voltage supply fails and a second function configured to copy the data previously stored in the flash memory to the volatile memory when the voltage supply returns.

2. The central subassembly as recited in claim 1, wherein the at least one external expansion module is in the form of an external input/output module and includes an interface configured to connected the external input/output module.

3. The central subassembly as recited in claim 1, wherein the data stored in the flash memory include remanent data stored in the volatile memory during operation of the automation device and usable by one of the application program and the operating system.

4. The central subassembly as recited in claim 1, further comprising an internal address/data control bus configured to interchange data between the volatile memory and the flash memory.

5. The central subassembly as recited in claim 1, further comprising a plurality of input and output circuits and a plurality of connecting elements configured to directly connect to the plurality of process signals.

6. The central subassembly as recited in claim 5, wherein the first electronic subassembly includes a plurality of first inputs and first outputs, and wherein the second electronic subassembly includes a second microcontroller connected to the plurality of first inputs and first outputs of the second microcontroller via input and output circuits, the second microcontroller configured to control and evaluate the plurality of process signals applied to the first inputs and first outputs.

7. The central subassembly as recited in claim 5, wherein the second microcontroller includes a parametrerizable input signal filtering for digital input signals.

8. The central subassembly as recited in claim 5, wherein the second microcontroller includes a fast counter function.

9. The central subassembly as recited in claim 5, wherein the second microcontroller includes an analogue/digital converter configured to detect analogue value inputs and includes a hardware structure configured to implement analogue value measurements and analogue value outputs, wherein operating software is configured to process the analogue value inputs and the analogue value outputs, and wherein the plurality of second inputs and the plurality of second outputs are configured to transmit the analogue value outputs to the digital/analogue converter.

10. The central subassembly as recited in claim 5, further comprising a serial communication interface connecting the first microcontroller to the second microcontroller.

11. The central subassembly as recited in claim 5, further comprising a plurality of parallel digital signal lines connecting the first microcontroller and the second microcontroller.

12. The central subassembly as recited in claim 1, further comprising a first, a second, and a third carrier, wherein the first, the second and the third electronic subassemblies are disposed respectively on the first, the second, and the third carrier, the third carrier being disposed between the second carrier and the first carrier.

13. The central subassembly as recited in claim 1, further comprising at least one of an Ethernet interface and a serial interface.

14. The central subassembly as recited in claim 1, further comprising an apparatus in the form of a slot configured to accommodate accessories that can be retrofitted.
